(19) United States
(12) Patent Application Publication
(10) Pub. No.: US 2014/0319747 A1
(43) Pub. Date: Oct. 30, 2014

(54) FIXTURE FOR EJECTOR PINS

(71) Applicants: HON HAI PRECISION INDUSTRY CO., LTD., New Taipei (TW); HONG FU JIN PRECISION INDUSTRY (ShenZhen) CO., LTD., Shenzhen (CN)

(72) Inventors: HAO YUAN, Shenzhen (CN); LONG ZHANG, Shenzhen (CN); DONG-CHUN WU, Shenzhen (CN)

(73) Assignees: HON HAI PRECISION INDUSTRY CO., LTD., New Taipei (TW); HONG FU JIN PRECISION INDUSTRY (ShenZhen) Co., LTD., Shenzhen (CN)

(21) Appl. No.: 14/135,132

(22) Filed: Dec. 19, 2013

(30) Foreign Application Priority Data
Apr. 29, 2013 (CN) 2013101550409

(51) Int. Cl. B25B 1/18

(52) U.S. Cl. CPC B25B 1/18
USPC 269/25

(57) ABSTRACT

A fixture for a plurality of ejector pins includes a base, a cylinder, a plurality of clampers, and a rear board. The base includes a fixing member. The cylinder is mounted to the base. The plurality of clampers is located between the cylinder and the fixing member to fix the plurality of ejector pins. The rear board is located on one side of the base for positioning the plurality of ejector pins. The plurality of clampers is pressed by the cylinder to move to retain the plurality of ejector pins.

### BACKGROUND

1. Technical Field

The disclosure generally relates to fixture for ejector pins, especially for a fixture to fix the ejector pins.

2. Description of Related Art

A mold includes a number of ejector pins for ejecting a molding product from a male mold or a female mold. The ejecting pins are standard parts inserted into the mold before use. Each ejector pin needs to be manufactured to be applied with the mold because different molds have different specifications. Main manufacture process is to cut or grind the ejector pins. The ejector pins are manufactured one by one on a clamper by a traditional method. It is time consuming to make different ejector pins in accordance with all molds. There is need to improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of a fixture and a plurality of ejector pins of one embodiment.

FIG. 2 is similar to FIG. 1, but shown from another aspect.

FIG. 3 is an assembled view of the fixture of FIG. 1, and the plurality of ejector being fixed to the fixture.

FIG. 4 is a front view of the fixture of FIG. 3.

FIG. 5 is similar to FIG. 4, but shown the plurality of ejector pins in a manufacture state.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

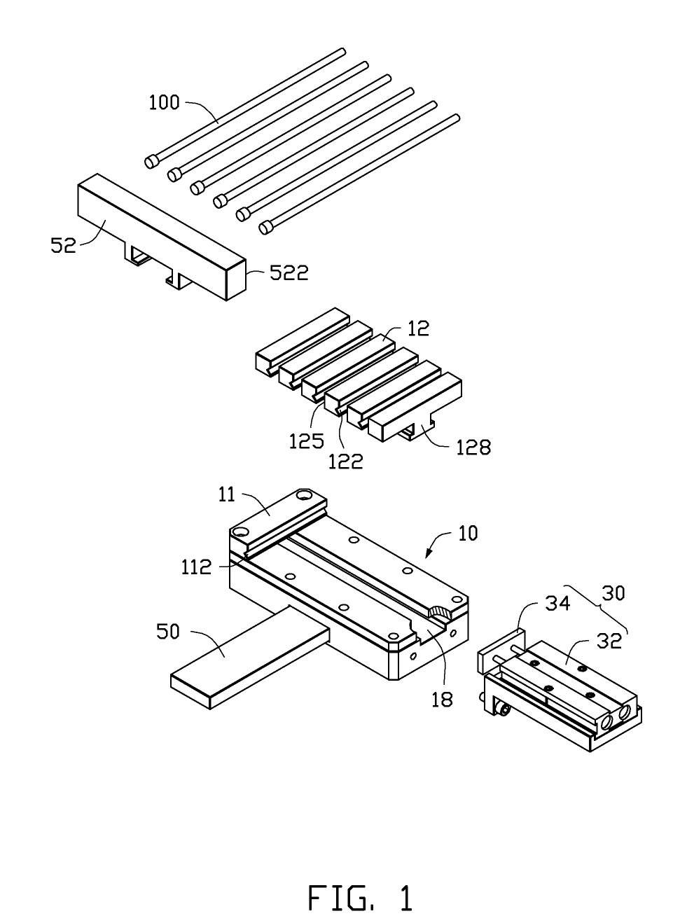

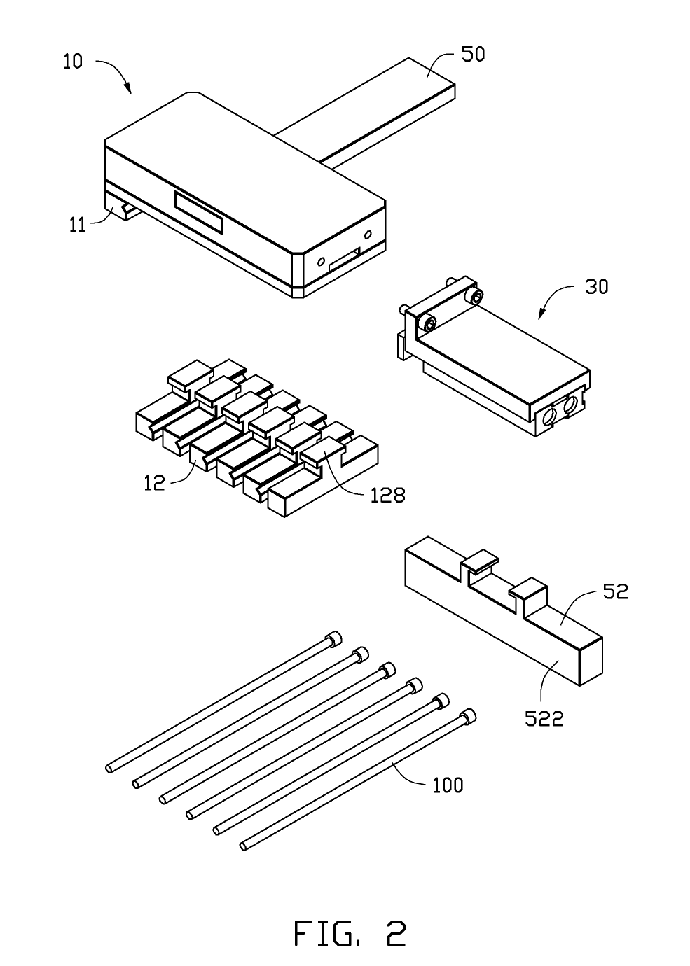

FIG. 1 and FIG. 2 illustrate one embodiment of a fixture for fixing a plurality of ejector pins 100. The fixture includes a base 10, a rail 50, a cylinder 30, a rear board 52, and a plurality of clampers 12.

The base 10 includes a fixing member 11. A first fixing slot 112 is defined in a lateral side of the fixing member 11. A cross-section of the first fixing slot 112 is substantially V-shaped. A guiding slot 18 is defined in the base 10. An extending direction of the guiding slot 18 is substantially perpendicular to an extending direction of the first fixing slot 112.

The cylinder 30 is mounted to one side of the base 10 away from the fixing member 11. The cylinder 30 includes a body 32 and pusher 34. The pusher 34 is moveable relative to the body 32.

The rail 50 is fixed to the base 10. An extension direction of the rail 50 is substantially parallel to the first fixing slot 112. The rear board 52 is slidably attached to the rail 50. The rear board 52 defines a plane contact surface 522 towards the base 10.

Each clamper 12 includes a slider 128 to engage with the guiding slot 18. Each clamper 12 defines a second fixing slot 122 and a vertical surface 125 on opposite side of the second fixing slot 122. An extension direction of each second fixing slot 122 is substantially parallel to the extension of the first fixing slot 112.

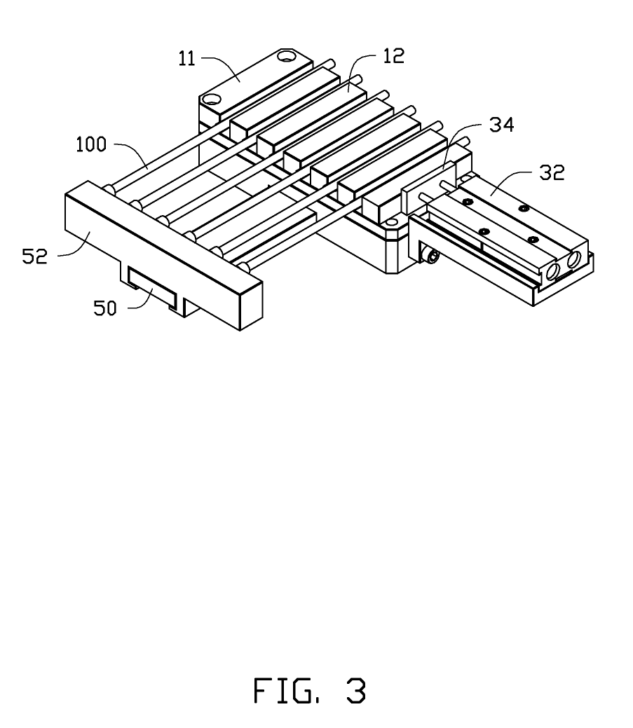

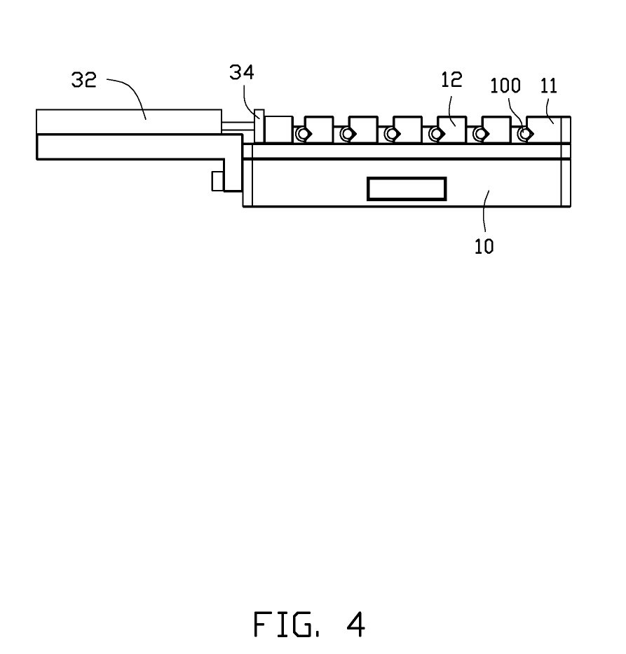

FIG. 3 and FIG. 4 illustrate two assembly views of the fixture to fix the plurality of ejector pins 100. In assembly, the rail 50 is mounted to the base 10. The rear board 52 is slidably mounted to the rail 50. The plurality of clampers 12 is aligned on the base 10 and is slidably mounted to the guiding slot 18. The plurality of dampers 12 is substantially parallel to each other and is substantially parallel to the fixing member 11.

When fastening the plurality of ejector pins 100, one of ejecting pins 100 is located between the fixing member 11 and the adjacent clamper 12. Each of other ejecting pins 100 is located between two adjacent clampers 12. A rear end of each ejector pin 100 abuts against the rear board 52. The rear board 52 is moved to adjust an exposed length of each ejector pin 100 out of the plurality of clampers 12. The cylinder 30 is actuated, and the pusher 34 pushes the plurality of clampers 12. The plurality of clampers 12 moves along the guiding slot 18 and fixes the plurality of ejector pins 100 in the first fixing slot 112 and the second fixing slots 122.

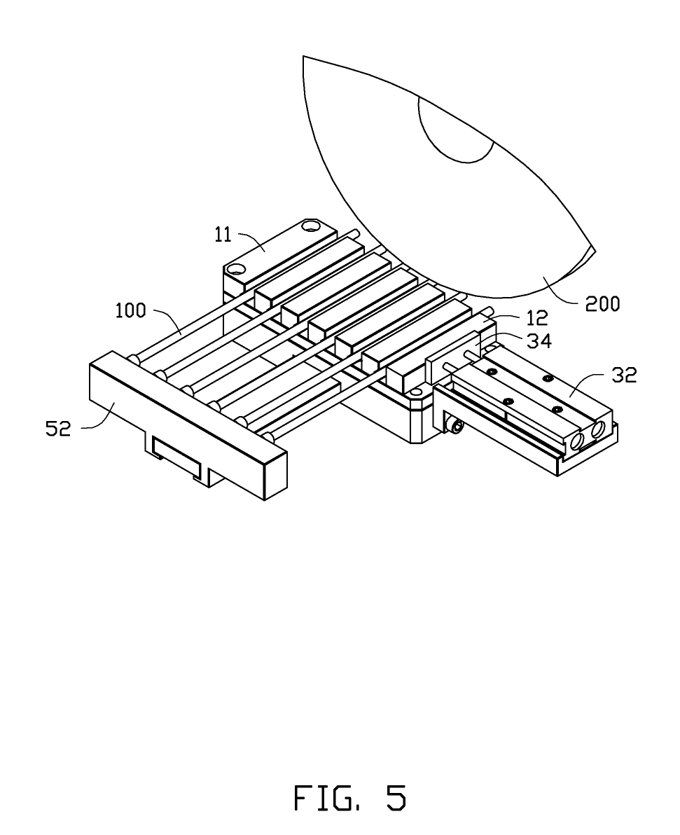

FIG. 5 illustrates a manufacturing state of the plurality of ejector pins 100. The plurality of ejector pins 100 can be cut off or can be ground by the grinding wheel 200. The fixture only needs manufacture the plurality of ejector pins 100 once.

It is to be understood, however, that even though numerous characteristics and advantages have been set forth in the foregoing description of embodiments, together with details of the structures and functions of the embodiments, the disclosure is illustrative only and changes may be made in detail, especially in the matters of shape, size, and arrangement of parts within the principles of the disclosure to the full extent indicated by the broad general meaning of the terms in which the appended claims are expressed.

What is claimed is:

1. A fixture for a plurality of ejector pins, comprising:
a base comprising a fixing member;
a cylinder mounted to the base;
a plurality of clampers located between the cylinder and the fixing member to fix the plurality of ejector pins; and
a rear board located on one side of the base and being configured to position the plurality of ejector pins,
wherein the plurality of clampers is configured to retain the plurality of ejector pins when the plurality of clampers is pressed by the cylinder.

2. The fixture of claim 1, wherein the plurality of clampers is slidably mounted to the base.

3. The fixture of claim 2, further comprising a rail, wherein the rear board is slidably mounted to the rail, and a sliding direction of the rear board is substantially perpendicular to a moving direction of each of the plurality of clampers.

4. The fixture of claim 1, wherein a first fixing slot is defined in the fixing member, and a second fixing slot is defined in each of the plurality of clampers.

5. The fixture of claim 4, wherein a cross-section of one of the first fixing slot and the plurality of second fixing slots is substantially V-shaped.

6. The fixture of claim 4, wherein an extending direction of one of the first fixing slot and the plurality of second fixing slots is substantially perpendicular to a moving direction of the plurality of clampers.

7. The fixture of claim 1, wherein the plurality of clampers has substantially same configuration.

8. The fixture of claim 1, wherein the rear board comprises a contact surface for positioning the plurality of ejector pins.

9. A fixture for a plurality of ejector pins, comprising:
a base comprising a fixing member;
a cylinder mounted to the base;
a plurality of clampers located on one side of the fixing member; and
a rear board located on one side of the base and being configured to position the plurality of ejector pins,
wherein the plurality of clampers is configured to retain the plurality of ejector pins between the fixing member and the plurality of clampers and between two adjacent clampers of the plurality of clampers when the plurality of clampers is pressed by the cylinder.

10. The fixture of claim 9, wherein the plurality of clampers is slidably mounted to the base.

11. The fixture of claim 10, further comprising a rail, wherein the rear board is slidably mounted to the rail, and a sliding direction of the rear board is substantially perpendicular to a moving direction of each of the plurality of clampers.

12. The fixture of claim 9, wherein a fixing slot is defined in each of the plurality of clampers.

13. The fixture of claim 12, wherein a cross-section of one of the plurality of fixing slots is substantially V-shaped.

14. The fixture of claim 12, wherein an extending direction of one of the plurality of fixing slots is substantially perpendicular to a moving direction of the plurality of clampers.

15. The fixture of claim 9, wherein the plurality of clampers has substantially same configuration.

16. The fixture of claim 9, wherein the rear board comprises a contact surface for positioning the plurality of ejector pins.
